(19) United States
(12) Patent Application Publication
(10) Pub. No.: US 2008/0288456 A1
(43) Pub. Date: Nov. 20, 2008

(54) INFORMATION NERVOUS SYSTEM

(76) Inventor: Nosa Omoigui, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 11/932,571

(22) Filed: Oct. 31, 2007

Related U.S. Application Data
(63) Continuation of application No. 11/548,627, filed on Oct. 11, 2006.
Application No. 11/548,627 is a continuation-in-part of application No. 10/781,053, filed on Feb. 17, 2004, now abandoned.
Application No. 10/781,053 is a continuation-in-part of application No. 10/179,651, filed on Jun. 24, 2002, now abandoned.
Application No. 10/179,651 is a continuation of application No. PCT/US02/20249, filed on Jun. 24, 2002.
(60) Provisional application No. 60/725,938, filed on Oct. 11, 2005.
(60) Provisional application No. 60/360,610, filed on Feb. 28, 2002.
(60) Provisional application No. 60/300,385, filed on Jun. 22, 2001.
(60) Provisional application No. 60/447,736, filed on Feb. 14, 2003.

(30) Foreign Application Priority Data
Feb. 14, 2004 (US) PCT/US2004/075466

(51) Int. Cl. G06F 17/30

(52) U.S. Cl. 707/3; 707/E17.001

(57) ABSTRACT

A semantically integrated knowledge retrieval, management, delivery and presentation system.

### COPYRIGHT NOTICE

This disclosure is protected under United States and International Copyright Laws. © 2002-2007 Nosa Omoigui. All Rights Reserved. A portion of the disclosure of this patent document contains material which is subject to copyright protection. The copyright owner has no objection to the facsimile reproduction by anyone of the patent document or the patent disclosure after formal publication by the USPTO, as it appears in the Patent and Trademark Office patent file or records, but otherwise reserves all copyrights whatsoever.

### BACKGROUND OF THE INVENTION

The following application is incorporated by reference as if fully set forth herein: U.S. application Ser. No. 11/548,627 filed Oct. 11, 2006. This invention relates generally to computers and, more specifically, to information management and/or research systems.

### BRIEF DESCRIPTION OF THE DRAWINGS

Preferred and alternative embodiments of the present invention are described in detail below with reference to the following drawings.

FIG. 1 is an Ontology Objects Table Data and Index Model according to an embodiment of the invention;

FIG. 2 is an Ontology Semantic Links Table Data and Index Model according to an embodiment of the invention;

FIGS. 3-6 are screenshots illustrating principles of at least one embodiment of the invention;

FIG. 7 is a Table Showing Semantic Search Qualifiers and Corresponding Predicates according to an embodiment of the invention; and

FIG. 8 is a screenshot illustrating principles of at least one embodiment of the invention.

### DETAILED DESCRIPTION OF THE PREFERRED EMBODIMENT

There will be debates, questions, etc. amongst users of the Information Nervous System on the appropriate queries to ask given the intent of the users. There might be a tendency to assume that this is a “problem,” and that the user should immediately be able to determine the right query given his/her intent. This is not necessarily a problem, but on the contrary can be an advantageous reflection of a natural and/or “Darwinian” process of context selection.

Intent and context are “curvy” and could have an arbitrary number of “geometric forms.” Indeed, it is great to see healthy debates and conversations on what the “right query” is, for a given user's intent. Part of this has to do with users having to become more familiar with the system. However, there will always be competing representations of semantic intent. This IS natural and healthy.

In a previously-filed commonly owned application, there was described what were called “entities.” Entities can include digital representations of abstract, personalized context. There may be competing entities within a community of knowledge. In one embodiment, users create and share entities INDEPENDENT of knowledge sources. In one scenario, an Entity Market could develop where domain experts could get bragging rights for creating and sharing the best entities in a given context. Human librarians could focus on creating and sharing the best entities for their organizations, based on their knowledge of ongoing projects and researchers' intent. Entities could even be shared across organizational boundaries by independent domain experts.

In one embodiment, users can be able to save and email entities to each other. The best entities will win. Again, this is natural.

In one embodiment, a user can be able to open an entity (sent, say, via email) in the Librarian and then drag and drop that entity to a Knowledge Community like Medline. Again, the entity is INDEPENDENT of the knowledge source. The entity could be applied to ANY knowledge source in ANY profile. With entities, context (and NOT content) is King.

In one embodiment, example of entities that would map to recent “debates on context” are:

1. HIV Infection (CRISP) and Immunologic Assay and Test (CRISP)

2. Plasmodium Falciparum (MeSH) AND Polymerase Chain Reaction (MeSH) AND (“diagnosis of malaria” OR “malaria diagnosis”)

Semantic stemming in the Knowledge Integration Service (KIS): In one embodiment, this allows the user to easily specify a qualified keyword that the KIS can interpret semantically. This can significantly aid usability, especially for those users that might not care to browse the ontologies, and for access from the simple Web UI. In one embodiment, the query, Find all chemicals or chemical leads relevant to bone diseases and available for licensing can now be specified simply as:

*:chemical “*:bone diseases” licensing

Or

*:chemical AND “*:bone diseases” AND licensing

1. The KIS maps *: to ALL supported ontologies and intelligently generates a semantic query (alternatively, the user can specify an ontology name to restrict the semantic interpretation to a specific ontology e.g., “MeSH:bone diseases”). In one embodiment, this implementation prunes the query. In one embodiment, the following pruning rules are employed:

A. Map the keyword to categories by calling the Ontology Lookup Manager (OLM). The OLM caches the ontologies that the KIS is subscribed to (via KDSes). The ontologies are zipped by the KDS and exposed via HTTP URLs. The KIS then auto-downloads the ontologies as KDSes are added to KCs on the KIS. The KIS also periodically checks if the ontologies have been updated. If they have, the KIS re-caches the ontologies. When an ontology has been downloaded, it is then indexed into a local Ontology Object Model (OOM). The data model is described in detail in the section titled “Semantic Stemming Processor Data and Index Model” below. The indexing is transacted. Before an ontology is indexed, the KIS sets a flag and serializes it to disk. This flag indicates that the ontology is being indexed. Once the indexing is complete, the flag is reset (to 0/FALSE). If the KIS is stopped or goes down while the indexing is in progress, the KIS (on restart) can detect that the flag is set (TRUE). The KIS can then re-index the ontology. This ensures that an incompletely indexed ontology isn't left in the system. Indexed ontologies are left in the KIS and are not deleted even when KCs are deleted.

B. If at least one ontology for a KC is still being indexed into the OOM and a semantic query comes in to the KIS (needing semantic stemming), the KIS uses the KDS for ontology lookup. In such a case, the fuzzy mapping steps below are employed. Else, the KIS employs the OLM, which invokes a semantic query on the Ontology Table(s) referred to by the semantic query. This first semantic query preferably acquires the categories from the semantic keywords (semantic wildcards). If there are multiple ontologies, a batched query can be used to increase performance (across multiple ontology tables in the OOM).

C. The modified time of ontologies at the KDS is the modified time of the ontology file itself and not of the ontology metadata file; this way, if only the ontology XML file is updated, that would be enough to trigger a KIS ontology-cache update.

D. For all returned categories (which could include many irrelevant categories because of poor document set analysis algorithms using context-less Latent Semantic Indexing or similar techniques), prune the list by checking for categories matching the qualified concept name (passed by the user)—when fuzzy mapping with the KDS is employed

E. If there are still no categories, perform a fuzzy string compare (e.g., bacterium □ bacteria)—when fuzzy mapping with the KDS is employed

F. If there are still no categories, add all the returned categories just to be safe—when fuzzy mapping with the KDS is employed

G. If there are still no categories, add a non-semantic concept corresponding to the passed concept name. The KIS defaults to a non-semantic filter if the specified filter cannot be semantically interpreted. This allows the user to be lazy by specifying the “*:” with the assurance that keywords can be used as a last resort.

H. Add the pruned categories to a local cache for super-fast lookup. The cache is guarded by a reader-writer lock since the cache is a shared resource. This ensures cache coherency without imposing a performance penalty with multiple simultaneous queries.

The cache is pruned after 10,000 entries using FIFO logic.

2. In one embodiment, the stemmer intelligently picks candidates on a per ontology basis—when fuzzy mapping with the KDS is employed. This way, selecting one good candidate from one ontology does not preclude the selection of other good candidates from other ontologies—even with a direct (non-fuzzy) match with one ontology.

Example:

*:chemical would map to chemical (CRISP) and Drugs and Chemicals (Cancer). Ditto for *:chemicals.

3. In one embodiment, when fuzzy mapping is employed more fuzzy logic is added to map terms in the semantic stemmer to close equivalents—e.g., *:Calcium Channel Calcium Channel Inhibitor Activity. This errs on the conservative side (supersets are favored more than subsets; subsets may require the same number of terms to qualify as candidates). In any event, even if the fuzzy logic results in false positives, the model still handles this and “bails itself out” (preferably the fuzzy logic, not unlike the ontology imperfections, are a form of uncertainty). The eventual filters soften the impact of this uncertainty.

4. In one embodiment, when fuzzy mapping is employed, added more predicate logic to correctly interpret complex queries that have field qualifiers. The KIS infers the union of predicates for complex queries that have a combination of different qualifiers. This is a semantic approximation in order to guarantee fast graph traversal. However, by restricting the predicate set to the union set (as opposed to all predicates), this significantly increases precision for these query types.

Example: Find all research on Heart or Bone Diseases published by Merck or published in 2005:

Dossier on (“*:Heart Diseases” OR “*:Bone Diseases”) AND (affil:Merck OR pubYear:2005)

5. In one embodiment, the KIS adds a default concept filter check for ontology or cross-ontology qualified keywords (e.g., “*:bone diseases”). This addition is done for rank bucket 0 and for All Bets or Random Bets—preferably for non-semantic sub-queries. This guarantees high precision even with ontology-qualified keywords and for semantic knowledge types like Best Bets or Breaking News.

6. In one embodiment, when fuzzy mapping is employed, added more smarts to the KIS semantic stemmer. If the stemmer doesn't find initial candidates, it prunes the large (and often false-positive laden—due to context-less document analysis) category list from the KDS. It does this by eliding parent paths for all paths—ensuring that no included path also has an ancestor included. This heuristic works very well, especially since the KIS does its own semantic and context-sensitive inference (meaning the stemmer doesn't have to try to be too clever).

Example:

Find all recent press releases or product announcements on infectious polyneuritis:

Dossier on “*:infectious polyneuritis” this now returns results on polyneuritis and on the Guillain-Barre Syndrome, which IS also known as infectious polyneuritis.

7. In one embodiment, the semantic stemmer recognizes ontology name aliases.

So you can now have Dossier on Go-Bio:Apoptosis

I have added alias names for all our current ontologies. However, even if the alias name is not present, the KIS tries to infer the ontology name by performing a direct or fuzzy match. So Cancer:Kinase or NCI:Kinase would both work and both map to Cancer (NCI).

8. In one embodiment, the KIS semantic stemmer dynamically adds a non-semantic concept filter for an ontology qualified concept if the rank bucket is 0 or if the concept could not be semantically interpreted. This is beautiful because it works for all cases: if the concept could not be interpreted, the non-semantic approximation is used; if the concept was interpreted and the context is semantic (e.g., Best Bets or Breaking News), the non-semantic concept is not added so as not to pollute the results (since the concept has already been interpreted); if, on the other hand, the rank bucket is 0, the semantics don't matter so adding the concept is a good thing anyway (it increases recall without imposing a cost on precision), even if the concept has already been semantically interpreted.

1. In one embodiment, the invention includes a method to the KIS Web Service Interface for the Web UI integration. The KIS can now be passed a text string (including Booleans) which it can then map to a semantic query.

2. In one embodiment, the KIS automatically specifies the “since” parameter to the KIS Data Connector (if it detects this) to optimize the incremental indexing path. This is permits real-time knowledge communities (e.g., News) as it minimizes the number of redundant queries during incremental indexing (since there can be much more read-write contention—since it is a real-time service).

3. In one embodiment, the invention includes developments in the KIS asynchronous processing and work-item pipeline logic. The KIS uses the system thread-pool and EACH KC runtime object now has its own semaphore. This ensures that the KCs don't overwork the KDSes yet increases concurrency by allowing multiple KCs to index as fast as possible simultaneously (previously, a slow KC could block a faster KC while both were indexing).

4. In one embodiment, the central KIS runtime manager holds/increments a work reference count on each document sourced from each connector that is currently indexing (it releases/decrements it once it is done indexing the document). This fixes a problem where a KC connector would quickly “find” an RSS file and think it was done, even while the items within the RSS file were still being processed and indexed. This was benign until the connector tried to restart the index (if so configured)—leading to a situation where the same connector could be indexing the same data redundantly at the same time.

5. In one embodiment, the KIS supports broader time-sensitivity settings (needed for the new Medline index):

a. Every two months

b. Every three months

6. In one embodiment, the KIS maps extended characters to English-variants. For instance, the Guillain-Barre Syndrome is mapped to Guillain-Barre Syndrome.

In one embodiment, Semantic Wildcards is also integrated with Deep Info. The user is able to specify a request including (but not limited to) semantic wildcards and then navigate the virtual knowledge space using the request as context. The KIS returns category paths to the semantic client which can then be visualized in Deep Info (not unlike Category Discovery). The user is then be able to navigate the hierarchies and continue to navigate Deep Info from there.
In one embodiment, the categories are visualized in the Deep Info console. And then the tree can be directly invoked by the user to launch a semantic query off a related category once the user discovers a category from his/her launch point (returned categories need to be visualized differently from parent categories—perhaps in a different font/color). This could be a profile, keywords, document, entity, etc. In this case, it can be the request itself.
In one embodiment, there is a Request Deep Info, Profile Deep Info, and Application Deep Info—corresponding to different default launch points (in all cases, some Deep Info elements—like Categories in the News, etc.—are available). In other cases, the user can type in keywords in the Deep Info pane to “semantically explore” the keywords without explicitly launching a request.
In one embodiment, another launch point is the Clipboard—the Deep Info console has a Clipboard Launch Point (if there is something on the clipboard) for whatever is on the clipboard. This can be very powerful as it would the user to copy anything to the clipboard (text, chemical images, document, etc.), go to the Deep Info and then browse/explore without actually launching a request.

Some Deep Info metadata (like categories) can be returned as part of the SRML header (they are request-specific but result-independent).

In one embodiment, the KIS handles virtually any kind of semantic query that users might want to throw at it. See the following example:

Find recent research by Pfizer or Novartis on the impact of cell surface receptors or enzyme inhibitors on heart or kidney diseases

We can now handle this query as follows:

Dossier on (Pfizer or Novartis) AND (“*:Cell Surface Receptors” OR “*:Enzyme Inhibitors”) AND (“*:Heart Diseases” OR “*:Kidney Diseases”)

One of the semantically stemmed and generated sub-queries is shown below. The KIS invokes our unique semantic filtering, semantic and context-sensitive ranking, semantic stemming including dynamic concept interpretation, complex Boolean deterministic logic, AND fuzzy logic to support this very powerful query.

Generated Sub-Query #1

```
              SELECT TOP 120 *
              FROM [DOCUMENTS_EC8E8136-A928-4E8F-BFD4-
6832501EAAD0] doc INNER JOIN
                          [SEMANTICLINKS_EC8E8136-A928-4E8F-BFD4-
6832501EAAD0] sem0 ON doc.ObjectID = sem0.SubjectID AND doc.BestBetHint = 1
AND
                          sem0.BestBetHint = 1 AND sem0.PredicateTypeID IN (13,
12, 11, 10, 9, 8, 7, 6, 5, 2, 1) AND sem0.ObjectID IN
                            (SELECT ObjectID
                              FROM [OBJECTS_EC8E8136-A928-4E8F-BFD4-
6832501EAAD0]
                              WHERE (Uri IN
(‘NERV://NOVARTIS?TYPE=CONCEPT’, ‘NERV://PFIZER?TYPE=CONCEPT’)))
INNER JOIN
                          [SEMANTICLINKS_EC8E8136-A928-4E8F-BFD4-
6832501EAAD0] sem1 ON doc.ObjectID = sem1.SubjectID AND doc.BestBetHint = 1
AND
                          sem1.BestBetHint = 1 AND sem1.PredicateTypeID IN (13,
12, 11, 10, 9, 8, 7, 6, 5, 4, 3, 2, 1) AND sem1.ObjectID IN
                            (SELECT ObjectID
                              FROM [OBJECTS_EC8E8136-A928-4E8F-BFD4-
6832501EAAD0]
                              WHERE (Uri IN (‘NERV://1FFEB1D0-8AFD-475D-
9C4F-16BBD3AA82A7?TYPE=CATEGORY&PATH=CARDIOVASCULAR
DISEASES/HEART DISEASES’,
                                        ‘NERV://75CDAA80-A05F-4BFA-8D9C-
E1F9DB2A6F4C?TYPE=CATEGORY&PATH=FINDINGS AND DISORDERS
KIND/DISEASES DISORDERS AND FINDINGS/DISEASES AND
DISORDERS/DISORDER BY SITE/RESPIRATORY AND THORACIC
DISORDER/THORACIC DISORDER/HEART DISEASE’,
                                        ‘NERV://75CDAA80-A05F-4BFA-8D9C-
E1F9DB2A6F4C?TYPE=CATEGORY&PATH=FINDINGS AND DISORDERS
KIND/DISEASES DISORDERS AND FINDINGS/DISEASES AND
DISORDERS/DISORDER BY SITE/CARDIOVASCULAR DISORDER/HEART
DISEASE’,
                                        ‘NERV://1FFEB1D0-8AFD-475D-9C4F-
16BBD3AA82A7?TYPE=CATEGORY&PATH=UROLOGIC AND MALE GENITAL
DISEASES/UROLOGIC DISEASES/KIDNEY DISEASES’)))
                          INNER JOIN
                          [SEMANTICLINKS_EC8E8136-A928-4E8F-BFD4-
6832501EAAD0] sem2 ON doc.ObjectID = sem2.SubjectID AND doc.BestBetHint = 1
AND
                          sem2.BestBetHint = 1 AND sem2.PredicateTypeID IN (13,
12, 11, 10, 9, 8, 7, 6, 5, 4, 3, 2, 1) AND sem2.ObjectID IN
                            (SELECT ObjectID
                              FROM [OBJECTS_EC8E8136-A928-4E8F-BFD4-
6832501EAAD0]
                              WHERE (Uri IN (‘NERV://C2573970-E4F6-4454-
9A12-5CEA7D7E1250?TYPE=CATEGORY&PATH=CHEMICAL/DRUG AND
AGENT/INHIBITOR AND ANTAGONIST/ENZYME INHIBITOR’,
                              ‘NERV://1FFEB1D0-8AFD-475D-9C4F-
16BBD3AA82A7?TYPE=CATEGORY&PATH=CHEMICAL ACTIONS AND
USES/PHARMACOLOGIC ACTIONS/MOLECULAR MECHANISMS OF
ACTION/ENZYME INHIBITORS’,
                                        ‘NERV://75CDAA80-A05F-4BFA-8D9C-
E1F9DB2A6F4C?TYPE=CATEGORY&PATH=CHEMICALS AND DRUGS
KIND/DRUGS AND CHEMICALS/DRUGS AND CHEMICALS FUNCTIONAL
CLASSIFICATION/PHARMACOLOGIC SUBSTANCE/ENZYME INHIBITOR’,
                                        ‘NERV://75CDAA80-A05F-4BFA-8D9C-
E1F9DB2A6F4C?TYPE=CATEGORY&PATH=GENE PRODUCT KIND/GENE
```

In one embodiment, one can type in ontology qualified or multi-ontology qualified search terms and the Librarian can semantically highlight relevant terms. So for example, one can now type Dossier on “*:bone disease” and the semantic client can do the smart thing.

Since ontology-qualified terms are dynamically interpreted based on the current profile, the semantic client maps the terms (e.g., “*:bone disease”) to the ontologies for the request profile. For multi-ontology mapping (prefixed with “*:”), the semantic client figures out the ontologies for the request profile and add semantic highlight terms for each of these ontologies. However, going through 6 ontologies (e.g., for Medline) has an impact on performance. Furthermore, the user could (in the limit) have a profile with tens of KCs each of which have several different ontologies. As such, a more pragmatic, fuzzy algorithm was called for. In one embodiment,

a) The Librarian first starts a timer to time the mapping process. This is configurable and can be switched off to have no timer.

b) The Librarian then tries all the ontologies in the request profile in the order of ontology size. This ensures that it flies through smaller ontologies.

c) If the ontology returns in less than a second, the timer (if available) is reset. This ensures that many small ontologies don't preclude the generation of terms from larger ontologies that await downstream in time.

d) Once the Librarian finds an ontology that has the semantic terms, it stops. This is a good trade-off because the alternative is to greedily check all ontologies for the terms. This isn't practical and wouldn't buy much because there is a fair chance that the ontologies have good terms for the desired concept (if they have the concept at all). In other words, the likelihood is that an ontology either has good terms for a concept or doesn't support the concept, period.

e) The Librarian continues to hunt for semantic terms with the remaining ontologies until the timer expires. Currently, there is a timeout of 10 seconds.

f) The mapping process using XPath to find every descendant of every category that has a hook corresponding to the desired concept. This entailed loading the XML document, finding all the hooks with the concept name, cloning the iterator, navigating to the parent category, and then selecting all the descendants of the parent category.

g) When the Presenter attempts to ask for the highlight hit list, the semantic runtime client now waits for the hit generation for 10 seconds (if configured to have a timer). This is MORE than enough time for most queries but also prevents the system from locking up in case the user has a query with, say, 20, cross-ontology qualifiers (this could hang the system).

h) All in all, this algorithm is stable and provides the user with a very high probability of always getting most or all the right terms (with “*:”) or all the right terms with specific categories or keywords, WITHOUT making the system vulnerable to hangs with, say, arbitrary queries with a profile with many arbitrary KCs.

Support parenthesized filters on categories
In one embodiment, the system supports parenthesized category filters.
Semantic client correctly highlights hooks included in “NOT” predicates
In one embodiment, Dossier on Autoimmune Diseases AND NOT on Multiple Sclerosis excludes Multiple Sclerosis terms from the highlight list.
Semantic client should stop exploding complex search queries (KIS now handles this)
In one embodiment, the KIS now handles all complex Boolean logic so the Librarian doesn't have to do this anymore.
Highlighting with categories that have single or double quotes)

In one embodiment, the XPath query uses double-quotes (consistent with the XPath spec).
Export and import speed up with ontology downloads and hit cache included

In one embodiment, the semantic client excludes ontology and highlighting hit cache state from import/export. The Librarian regenerates the hit cache after an import.

In one embodiment, the invention involves KIS asynchronous processing and work-item pipeline logic. This should fix some hard-to-repro indexing race conditions where the KIS occasionally misses some items to be indexed. The KIS uses the system thread-pool and each KC runtime object now has its own semaphore. This ensures that the KCs don't overwork the KDSes yet increases concurrency by allowing multiple KCs to index as fast as possible simultaneously.

In one embodiment, the central KIS runtime manager holds/increments a work reference count on each document sourced from each connector that is currently indexing (it releases/decrements it once it is done indexing the document). This prevents where a KC connector would quickly “find” an RSS file and think it was done, even while the items within the RSS file were still being processed and indexed. This was benign however, until the connector tried to restart the index (if so configured)—leading to a situation where the same connector could be indexing the same data redundantly (albeit maybe benignly, yet perhaps dangerously), at the same time.

Many of the articles that are in the news-feeds we get contain ads.

However, these ads are problematic because they affect the ability of the KIS to semantically filter and rank properly. For instance, some web pages contain several times (at times more than 5 times) as much ad content as the actual content for the article.

In various embodiments:

1. Assume that all articles contain ads. The news connector can indicate this in the generated RSS. The KIS takes this as a signal not to follow the link (this is what currently happens for Medline). Due to the KIS' Adaptive Ranking algorithm, the KIS is able to semantically rank on a relative basis so that the “best” descriptions can still be returned first.

2. Implement a Safe List. The Safe List can be manually maintained initially. This can contain a list of publisher names that don't include ads. A good example is the Business-Wire which includes press releases. We can manually maintain the Safe List as part of our ASP value proposition in the short-term. The News Connector can check the Safe List and if the publisher is deemed safe, can indicate to the KIS that it can safely index the entire document.

3. Automate the Safe List. A set of algorithms to automate the population and maintenance of the Safe List. This involves populating a Safe Candidate List, which can then be periodically scanned by humans. Humans are responsible for what goes into the Safe List. The auto-population can be based on detecting those URLs that have “Printable Page” links. If these are detected, the connector can indicate to the KIS that it should index the printable pages. These generally don't contain ads.

4. Implement add content-cleansing to the Staging Service. Content-cleansing attempts to use heuristics, machine learning, and layout analysis to automatically detect whether a page has ads. If ads are detected, the service can then attempt to extract the subset of the document that is the meat of the document (as text) and then indicate to the KIS (via RSS signaling) that the KIS should index that document.

In one embodiment, a combination of all three processes addresses this issue.

Ad-Removal Rule #1, in accordance with an embodiment of the invention

For every HTML page (I have code for this—a URL not in the HTML exclusion list or a URL that has a query [Uri uri=new Uri(url); if ((uri.Query !=String.Empty) && (uri.Query !=“?”))].

If the web page contains a link (walk the link list using SgmlReader, which converts HTML to XHTML—see last URL I emailed you; use XPath to walk the list) with any of the following titles (case-insensitive comparison):

1. “Text only”

2. “Text version”

3. “Text format”

4. “Text-only”

5. “Text-only version”

6. “Text-only format”

7. “Format for printing”

8. “Print this page”

9. “Printable Version”

10. “Printer Friendly”

11. “Printer-Friendly”

12. “Print”

13. “Print story”

14. “Print this story”

15. “Printer friendly format”

16. “Printer-friendly format”

17. “Printer friendly version”

18. “Printer-friendly version”

19. “Print this”

20. “Printable format”

21. “Print this article”

And if the link is not JavaScript (which launches the print dialog) . . . .

Add the linkToBeIndexed tag to the generated RSS and point it to the printable link.

Also detect the “print” icon with the “print” tool tip (or any tool tip with text mapping to any of the above), and apply the same rule.

Ad-Removal Rule #2, in accordance with an embodiment of the invention

Cache the stats on host names for which rule #1 works. Add the host names to a “safe list candidates” file. Validate those candidates and add them to the safe list. Also add items to the safe list based on submissions from trusted people (e.g., within Nervana and/or Beta customers).

Ad-Removal Rule #3, in accordance with an embodiment of the invention

Apply the current rules (per description length, etc.) □ since these also save network I/O

If the item is recommended for addition:

```
            If the hostname for an item is in the safe list,
            Add it as “follow” with the inserted linkToBeIndexed tag
                        Else
                              Run rule #1
                              If the item is a safe candidate
                                    Add the host name to the “safe candidate list” file
(if it isn’t there already - use a hash table for quick comparison)
                                    Add it as “follow” with the inserted
linkToBeIndexed tag
                              Else
                                    Add it as “nofollow”
                  Else
```

Add it as “nofollow”

As users/testers use the KCs, and if they see a pattern of content that don't contain ads, they email the URL and the Publisher (via the Details Pane) to Nervana to add to the Safe List. Over time, this can accrete and can increase the recall of the system.

These ad removal and cleansing rules are also employed at the semantic client during Dynamic Linking (e.g., Drag and Drop or Smart Copy and Paste). For example, if the user drags and drops a Web page, the cleansing rules are first invoked to generate text that does not contain ads. This is done BEFORE the context extraction step. This ensures that ads are not semantically interpreted (unless so desired by the user—this can be a configurable setting).

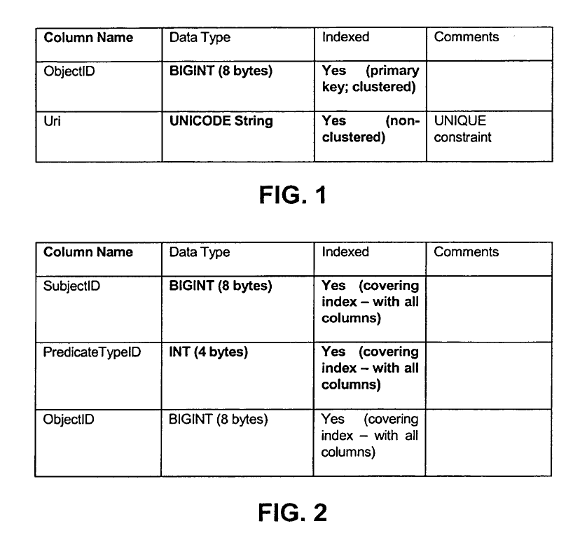

Referring to FIGS. 1-2, in one embodiment, there is also a composite index which is the primary key (thereby making it clustered, thereby facilitating fast joins off the SemanticLinks table since the database query processor can be able the fetch the semantic link rows without requiring a bookmark lookup) and which includes the following columns:

1. SubjectID

2. PredicateTypeID

3. ObjectID

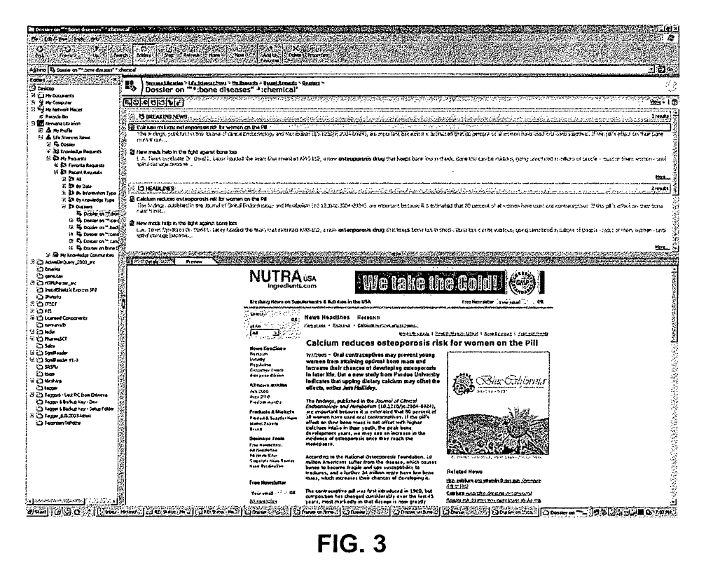

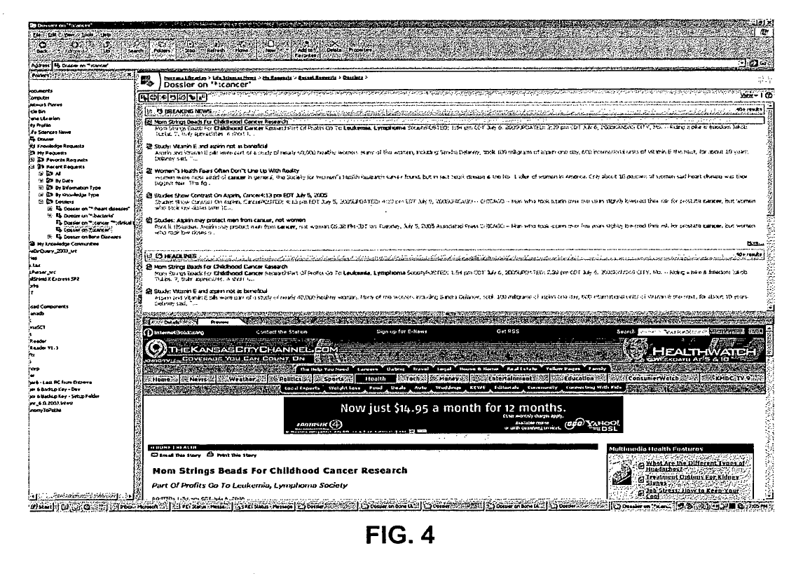

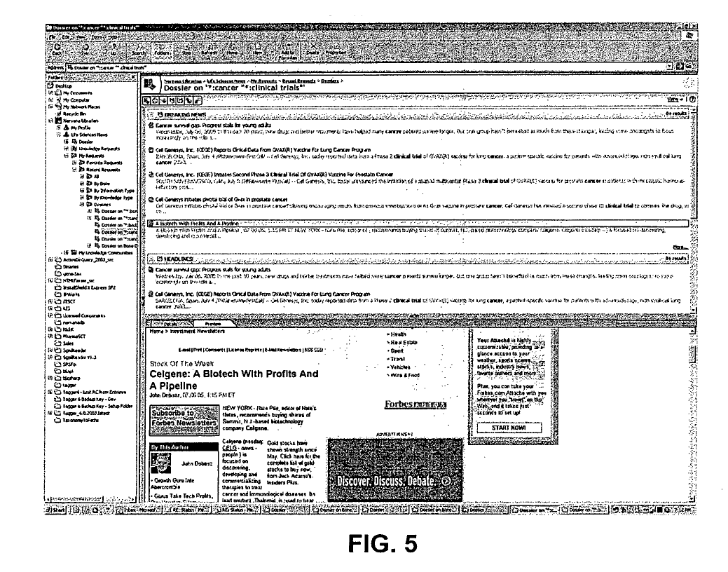

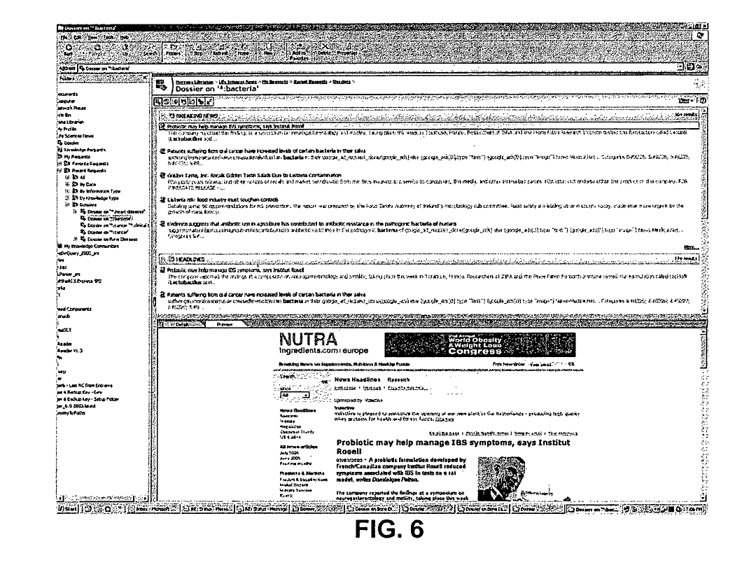

The following discussion generally refers to FIGS. 3-6:

1. Find me Breaking News on Chemical Compounds Relevant to Bone Diseases □ Dossier on “*:bone diseases” chemical

2. Find me Breaking News on Cancer □ Dossier on *:cancer

3. Find me Breaking News on Cancer-Related Clinical Trials □ Dossier on “*:clinical trials”*:cancer

4. Find me Breaking News on Bacteria □ Dossier on *:bacteria

In one embodiment, the Life Sciences News KC can periodically ask the General News KC (during its real-time indexing process) for Breaking News on *:Health OR “*:Health Care” OR “*:Medical Personnel” OR *:Drugs OR “*:Pharmaceutical Industry” OR *:Pharmacology OR “*:Medical Practice”

This KC was populated based on editorial rules, based on tags provided by our news provider, to determine which sources and articles are Life-Sciences-related.

Currently, the rate of traffic for the General Reference channel on the News connector is much higher than that for Life Sciences. This makes sense.

However, it is conceivable that there is Life-Sciences-related content in General News that we also need to index in Life-Sciences News (with all 6 ontologies).

In one embodiment, this is accomplished using KIS-Chaining (this is already part of our IP portfolio). The Life Sciences (LS) News KC can ALSO point to the General News KIS (once it is up and running) via the new KIS RSS interface. The RSS can include a reference to *:Health OR “*:Health Care” OR “*:Medical Personnel” OR *:Drugs OR “*:Pharmaceutical Industry” OR *:Pharmacology OR “*:Medical Practice”

These come from the General Reference and Products & Services ontologies, which the General News KC can be indexed with.

Preferably, the LS News KC indexes the Health subset of the General Reference KC.

Other vertical KCs (e.g., IT, Chemicals, etc.) also employ the same approach to ensure they have the most relevant yet broad dataset to index. And that way, we don't rely too much on the tags that come from Moreover to figure out which articles are Life-Sciences-related.

In one embodiment, the approach described below is then used for the IT News KC and Vertical KCs (as we expand to more verticals).

The approach can also be used to funnel (or tunnel, depending on your perspective) traffic from the General Patents KC to the Life Sciences Patents KC (and other vertical Patents KCs in the future).

In one embodiment is preferable to track the traffic for Breaking News for the following categories (ORed) from General News and compare that with the traffic on Breaking News on the Life Sciences KC.

This tells us that our Life Sciences KC is currently underserved with content due to the incomplete industry tagging metadata we get from our news provider.

We then funnel content from the General News KC to the Life Sciences News KC via machine-to-machine KIS Chaining as previously described.

It is OK if these categories represent overly broad context. The Life Sciences News KC can still do its job and semantically filter and rank the articles according to its 6 Life Sciences ontologies. This is akin to chaining perspectives and then performing “perspective switching and filtering” downstream.
Clinical Tests of Medical Procedures OR
Drugs OR
Forensic Medicine OR
Group Medical Practice (all contexts) OR
Health OR
Health Care OR
Health Insurance OR
Home Medical Tests OR
Medical Equipment OR
Medical Ethics OR
Medical Examiners OR
Medical Expense Deduction OR
Medical Malpractice OR
Medical Personnel OR
Medical Records OR
Medical Research OR
Medical Savings Accounts (all contexts) OR
Medical Schools OR
Medical Screening OR
Medical Supplies OR
Medical Technology OR
Medical Wastes OR
Pharmaceutical Industry OR
Pharmacology OR
Preventive Medicine OR
Sports Medicine OR
Telemedicine OR
Biological Clocks OR
Biological Diversity (all contexts) OR
Biology OR
Biologists OR
Biological and Chemical Weapons (all contexts) OR
Biotechnology OR
Agricultural Biotechnology OR
Genetics OR
Anatomy and Physiology OR
Animal Care OR
Animals OR
Aquatic Life OR
Births OR
Chemicals OR
Child Care OR
Child Development OR
Children and Youth OR
Cognition and Reasoning OR
Contamination OR
Death and Dying OR
Environment OR
Farming OR
Females OR, etc
Flowers and Plants
Food
Food Processing Industry
Food Products
Food Service
Food Service Industry
Gardens and Gardening
Hazardous Substances
Hazards
Life
Life Cycles
Livestock Industry
Males
Membranes
Memory
Menstruation
Mental Disorders
Molecules
Nature
Organisms
Personal Relationships
Proteins
Psychiatry
Reproduction
Social Research
Zoology
Social Psychology
Sociology
Scientific Imaging
Ecologists
Sexes
Sexual Behavior
Sleep
Sleep Disorders
Speech
Stress
Urology
Waste Disposal
Waste Management Industry
Waste Materials
Water Treatment
Wildlife Management
Wildlife Observation
Wildlife Sanctuaries

As an example of the inferiority of present search techniques, read this: http://www.stn-interational.de/training_center/patents/pat_forO0602/prior_art_engineering.pdf

Search Question:

“Find patent and non-patent prior art for the use of dielectric materials in cellular telephone microwave filters”

Manual Prior Art Search Strategy:

Step 1: Quick search in COMPENDEX to identify relevant terminology

Step 2: Develop search strategy using COMPENDEX and INSPEC thesaurus terminology.

Step 3: Modify search terms for use in WPINDEX

Step 4: Identify appropriate IPCs and Manual Codes

Step 5: Explore Thesauri for Code definitions

Step 6: Refine strategy

Step 7: Identify LEXICON terms for a CAplus search

Step 8: Combine, de-duplicate, sort and display results

(Dielectrics OR Ceramic materials OR Dielectric materials) AND

(Mobile phones OR Telecommunications OR Handy OR Cellular phone OR Portable phone

OR Wireless communication OR Cordless communication OR Radiophone) AND (Microwave

OR High frequency OR High power OR High pulse OR High waveband)

In contrast, in one preferred embodiment of Nervana's system, this is done with one powerful, natural semantic query:

Check out the Engineering ontology in the semantic client. It has everything needed for this query: “dielectric materials” AND “microwave filters” AND “cellular telephone systems”

The painful keyword search below can be replaced by a simple Nervana semantic search on an Engineering Patents KC indexed with the Engineering ontology for

“*:dielectric materials” AND “*:cellular telephone” AND “*:microwave filters”

In one embodiment, the Information Nervous System adds multi-dimensional semantic ranking.

Query examples follow, in accordance with an embodiment of the invention.

Find me News on chemical compounds relevant to the treatment of bone diseases:
Dossier on “*:bone diseases”*:chemicals

Find me News on chemical compounds relevant to the treatment of musculoskeletal or heart diseases:
Dossier on *:chemicals AND (“*:musculoskeletal diseases” OR “*:heart diseases”)

Find me News on autoimmune, cardiovascular, kidney, or muscular diseases:
Dossier on “*:autoimmune diseases” OR “*:cardiovascular diseases” OR “*:kidney diseases” OR “*:muscular diseases”

Find me latest News on work Pfizer, Novartis, or Aventis are doing in cardiovascular diseases:
Dossier on “*:cardiovascular diseases” AND (Pfizer or Novartis or Aventis)

Find me latest News on cell surface receptors relevant to all types of Cancer:
Dossier on “*:cell surface receptor”*:cancer

Find me latest News on enzyme inhibitors or monoclonal antibodies:
Dossier on “*:enzyme inhibitors” OR “*:monoclonal antibodies”

Find me latest News on genes that might cause mental disorders:
Dossier on *:genes “*:mental disorders”

Find me latest News on ALL protein kinase inhibitors or biomarkers but only in the context of cancer:
Dossier on “cancer:protein kinase inhibitors” OR cancer:biomarkers

Find me latest News on Cancer-related clinical trials:
Dossier on “*:clinical trials”*:cancer

Find me latest News on clinical trials on heart or muscle diseases:
Dossier on “*:clinical trials” AND (“*:heart diseases” OR “*:muscle diseases”)

I want to track news on the Gates Foundation's Grand Challenge titled “Develop a genetic strategy to deplete or incapacitate a disease-transmitting insect population”
Dossier on *:genetics *:diseases *:insects

I want to track news on the Gates Foundation's Grand Challenge titled “Develop a chemical strategy to deplete or incapacitate a disease-transmitting insect population”
Dossier on *:chemicals *:diseases *:insects

Find me research news highlighting the role of genetic susceptibility in pollution-related illnesses.
Dossier on *:genetics *:pollution *:diseases

More examples, in accordance with various embodiments of the invention.

1. Find research by Amgen or Genentech on chemical compounds used to treat autoimmune diseases:

Dossier on AutoImmune Diseases (MeSH) AND Chemical (CRISP) AND (Amgen OR Genentech) a this works today (another common example is to filter by year a e.g., (2004 or 2005))

2. Find research by Roche or Pfizer published in the past three years on the use of protein kinase or cyclooxygenase inhibitors to treat Lung or Breast Cancer:

Dossier on (“*:Protein Kinase Inhibitor” OR “*:cyclooxygenase inhibitor”) AND (“*:Lung Cancer” OR “*:Breast Cancer”) AND (Roche or Pfizer) AND (range:2003-2005)

Here is an alternative (our unique semantic stemming technology handles semantic variants and dynamically interprets keywords ACROSS ontologies) a this works across ALL unstructured data repositories:

Dossier on (“*:Protein Kinase Inhibitor” OR “*:COX Inhibitor”) AND (“*:Lung Cancer” OR “*:Breast Cancer”) AND (Roche or Pfizer) AND (range:2003-2005)

Here is a more specific alternative (with Semantic Medline) as this may return only articles published by Roche or Pfizer (and utilizes the metadata available on Medline—or other sources like Patents and News; Nervana maps the fields to canonical forms):

Dossier on (“*:Protein Kinase Inhibitor” OR “*:COX Inhibitor”) AND (“*:Lung Cancer” OR “*:Breast Cancer”) AND (affiliation:Roche or affiliation:Pfizer) AND (pubyear:2003-2005)

In one embodiment, *: provides a close to natural-language query.

*: provides semantic stemming and semantic reasoning to INFER or deduce what terms MEAN IN A GIVEN CONTEXT IN A GIVEN PROFILE, NOT merely synonyms or other word forms of the terms.

The Information Nervous System (read preferred embodiments of: The Nervana System) also semantically ranks results with *: queries IN THE CONTEXT of the desired terms/concepts. This is NOT the same as mapping the query to a long Boolean query nor is it the same as ranking the synonyms of the terms.

In other words, a Dossier on “*:bone diseases” AND *:chemicals is NOT mathematically equivalent to a Boolean search for every type of bone disease (OR'ed) AND every type of chemical (OR'ed) BECAUSE OF CONTEXT-SENSITIVE RANKING.

In one embodiment, to increase recall, the KIS (on indexing incoming content from news feeds and other sources) adds the following logic:

1. If you cannot extract the description and the metadata description is empty, mark it as unsafe for follow. Then add the “safe” column to the composite constraint that includes Title and Accessible.

2. If a new article comes in with the same title as something you have already *attempted* to extract and the new one can be extracted, you replace the one that failed with the new one.

3. Mark https URLs as unsafe to follow (may require subscription)

In one embodiment, with privacy provisions, the KIS *anonymously* logs semantic searches and uses those logs to improve our ontologies.

Actual searches are a great window to actual REAL-WORLD vocabularies being used—including typos and other word-forms that our ontologies might currently lack.

This idea relates to an end-to-end ontology service/system (with a Web application and Web services) that allows ontologists to view logs and statistics and loop that back into the ontology improvement process. This is tied to an ontology management tool via Web services. An ontology research and development team that can own the statistical analysis of search logs, ontology semi-automation, and *distributed* ontology development tools. The ontology tools have collaboration functions and to be tied into online communities and Wikis. Customers are able to recommend ontology improvements from the Librarian and Web UI and have that propagated to the ontology analysis and development team in real-time.
Deny potential Denial-of-Service Attack when range: tag is used

In one embodiment, the KIS will not exceed 1000 (or any N) numbers in the range tag to guard against a DOS attack.

In one embodiment, Deep Info Hyperlinks are a visual tool in the Information Nervous System, used to complement the Deep Info pane. Deep Info Hyperlinks allow the user of the semantic client to navigate Deep Info preferably in a manner partially resembling navigating hyperlinks. This allows the user to be able to continuously navigate the semantic knowledge space, via Dynamic Linking, without any limitations based on the size of the knowledge space (which could exceed the amount of available UI real estate in say, a tree view). There can be a Deep Info stack to track “Back,” “Forward” and “Home”. For non-root category nodes in Deep Info, there can also be an enabled “Up” button to allow the user to navigate to the parent category in a given ontology.

In one embodiment, Deep Info results (actual documents, people, etc.) can be restricted to the first major level in the tree (i.e., a result should not have a tree expansion which then shows more results—in the same in-place tree UI). Context templates (special agents or knowledge requests) can be displayed, along with previews of results there from, but thereafter the user would have to navigate to the template itself (e.g., Breaking News) to get more information—e.g., discovered categories with the template/special-agent as a pivot. Category hierarchies are reflected in the tree as deep as is needed. The user can then navigate to a result, category, etc. and then continue the navigation from there—without overloading the UI.

In the provisional application from which this application claims priority, Deep Info Hyperlinks are indicated with the underlined text. Also, notice the Back, Forward, Stop, Refresh, Home, Mail, and Print buttons (no different from a hypertext web browser). The user is able to navigate the Deep Info knowledge space (via Dynamic Linking) by recursively clicking on the Deep Info Hyperlinks and by going “Back” and “Forward,” as desired. Clicking Home would take the user back to the starting “Deep Info position” (either for application-wide or profile-wide Deep Info or to the context point from where the Deep Info semantic chain was launched). Clicking Refresh would refresh the Deep Info pane, in a manner partially resembling refreshing a loaded web page in a Web browser. Clicking Stop would stop the pane from loading. Clicking Mail would email the Deep Info XML contents to a person or group of persons. Clicking Print would print the Deep Info pane.

In one embodiment, the Deep Info Hyperlinks also have a drop-down menu to allow the user launch a new request (or entity) corresponding to the clicked Deep Info node.

Furthermore, in one embodiment, each entry in the Deep Info Hypertext space has a legitimate launch point for a new request, bookmark, or entity. The user is able to create a new request, bookmark, or entity (opened in place or “explored”—opened in a new window). The system intelligently maps the current node to a request, bookmark, or entity, based on the semantics of the node. For instance, a category is mapped to a Dossier on that category (by default and exposed in the UI as a verb/command) or a “topic” entity referring to the category (as another option, also exposed in the UI as a verb/command). A context template (special agent or knowledge request) is mapped to a request with the same semantics and with the filter based on the source node (upstream) in the Deep Info pane. Some nodes might not be “mappable” (e.g., a category folder) and the UI indicates this by disabling or graying out the request launch commands in such cases.

In one embodiment, the clipboard launch point for Deep Info is automatically updated when the clipboard changes (via a timer or a notification mechanism for tracking clipboard changes) or can be left as is (until the user refreshes the Deep Info Pane). In one embodiment, the semantic client keeps track of the most recent N clipboard items (via the equivalent of a clipbook) and have those exposed in the Deep Info pane. The most recent clipboard item is displayed first (at the top). The “current” item should then be auto-refreshed in real-time, as the clipboard contents change. Also, if the current item on the clipboard (or any entry in the clipbook) is a file-folder, the Deep Info pane allows the user to navigate to the contents of that folder (shallowly or deeply, depending on the user's preference).

In one embodiment, there is at least two Deep Info Panes with Hypertext Bars—a main pane that encapsulates the semantic namespace and which is displayed everywhere in the namespace (in every namespace item console) and a floating pane (the Deep Info Minibar) which is displayed next to a selected result item. the main pane can allow the user to semantically explore all profiles but the current (contextual) profile is displayed first (highest in the tree, in the case of a tree UI, perhaps after the current request and clipboard contents Deep Info launch points). The Deep Info Minibar is displayed when the user selects an item (perhaps via a small button the user preferably must click first) and has the result item as an initial launch point (so as not to overload the UI). Also, the Deep Info Minibar includes a Deep Info path with “Annotations” off the result item itself (in addition to all the context templates and other Deep Info paths). The Minibar allows the user to explore—off the result item as a launch point—both the current (contextual) profile and other profiles in the system.

```
            [+] Current Request (Dossier on “*:Cardiac Failure”)
                  [+] MeSH
                              [+] Cardiovascular Diseases
                                    [+] Cardiac Failure
            [+] Clipboard Contents (Presentation: Life Sciences Market Forecast 2005-
2010.ppt)
                  [+] MeSH
                              [+] Catabolism
                                    [+] Protein Catabolism
[+] All Profiles
    [+] My Profile
      [+] Recommended Categories
            [+] Cancer
                  [+] Amino Acids
                        [+] Breaking News
[+] Headlines
                        [+] Newsmakers
                        [+] All Bets
                        [+] Best Bets
                        [+] Experts
                        [+] Conversations
                              [+] Mary Smith
                                    [+] Headlines
                              [+] Joe Johnson
                                    [+] Interest Group
                                    ...
                        ...
                  [+] Breaking News
[+] Headlines
                        [+] Newsmakers
                        [+] Best Bets
                        [+] Conversations
                              [+] Peter Marshal
                              [+] Kenneth Falk
                              ...
                              ...
      [+] Categories in the News
            [+] MeSH
                  [+] Cardiovascular Diseases
                        [+] Cardiac Failure
                        ...
      [+] Popular Categories
      [+] Best Bet Categories
      [+] My Categories
      ...
...
Legend:
  Blue: Ontology (Category Folder) for discovered category
  Red: Parent category for discovered category
    Green: Discovered category
```

FIG. 3: User Interface illustrating Deep Info Hyperlinks and Deep Info Toolbar

In one embodiment, the Deep Info pane flags each category in the hierarchy as belonging to Best Bets, Recommendations, or All Bets. This allows the user to visually get a sense of the strength of the Deep Info path (in this case a category) IN THE CONTEXT of the strength of the categories IN THE CONTEXT of the query or document (or the Deep Info source). This preferably becomes a hint to the user per how much time and effort to spend navigating different paths. So in the example below, the user can have a clear sense that Cardiac Failure is a Best Bet category, Dementia is a Recommended category, and that Immunologic Assays is an All Bets category. Also, there is a visual indicator showing if a category is [also] in the news (e.g. Dementia below)—the sample picture shown reads “NEW!” but in practice reads “NEWS.” There is also an indicator alongside each category folder showing the total category count, and the count for Best Bet, Recommended, and “In the News” categories. This provides the user with a visual hint as to the richness of the category results within a specific category folder (ontology) before he/she actually explores the category folder.

In one embodiment, in the case where a semantic wildcard query (or a category query) is the Deep Info source, the hints represent the relevance of the inferred categories in the corpus itself. Else, in the case of a document, the clipboard, text, etc., the hints represent the INTERSECTION of relevance of the inferred categories in the source AND the corpus (the index). As an illustration, if the Deep Info source is a document, the Best Bet hint for a Deep Info category can be set IF the category (or categories) are Best Bets in BOTH the source document AND the corpus. Ditto for Recommended categories (the category has to be at least a Recommendation in both source and destination). Else, the hint is indicated as All Bets. This preferably can guide the user to know the relevance of the categories ALONG the path, consistent with BOTH source and destination. If the category is weak in the source yet strong in the corpus, the intersection can tell the user same. If the category is strong in both, this is clearly the path to navigate first.

Here is an example, in accordance with an embodiment of the invention (see the legend below):

```
            [+] Current Request (Dossier on “*:Cardiac Failure” AND
“*:Dementia” AND “*:Immunologic Assays”)
                  [+] MeSH (15 total, 1 Best Bet, 4 Recommended,
                  2 in the News)
                              [+] Cardiovascular Diseases
                                    [+] Cardiac Failure
            [+] Mental Disorders
                                    [+] Dementia
            [+] Immunologic Techniques
                                    [+] Immunologic Assays
```

In one embodiment, this model (as described above per flagging categories in context via visual hints) also applies to People. This is consistent with the semantic symmetry I described in a previous invention submission. Experts are treated as Best Bets on the People axis, Interest Group are treated as Recommendations on the People axis, and Newsmakers are treated as Headlines on the People axis.

In one embodiment, as such, for a Person object in the Deep Info pane, the same model applies. However, the visual hints now indicate relevance based on Expertise, Interest, and News (per newsmakers). These visual hints for discovered categories are displayed in addition to the context templates (special agents or knowledge requests) also displayed for the Person/People in question. In one embodiment, the symmetric (People) visual hints supplement the Information hints (Best Bets, etc.). The visual hints are based on direct equivalents in the semantic networks in the KISes in the contextual profile—indeed the Category information returned in the Deep Info query has identical attributes to the BestBetHint, RecommendationHint, BreakingNewsHint, and HeadlinesHint in the semantic network. This is generic, however—these attributes can indicate whether the category is a Best Bet category, a Recommended category, a Breaking News category, or a Headlines category. In on embodiment, the KIS goes further and also return a hint to the semantic client indicating whether the Deep Info source (e.g., John Smith) below is a “Best Bet” (expert per semantic symmetry), “Recommendation” (interest group per semantic symmetry), Breaking News (breaking newsmaker per semantic symmetry) and/or Headlines (newsmaker per semantic symmetry). The KIS accomplishes this by querying for these hints from categories in the Objects table (or Categories table in an alternate embodiment) and joining this against the People table with the filter indicating whether the person (“John Smith” in this case) has a semantic link to the category.

An illustration of the People visual hints is shown below, in accordance with an embodiment of the invention. The balloon tool tips show additional Deep Info visual hint qualifiers on the People axis, specifically related to the Person in question (in this case, John Smith).

```
            [+] John Smith
                  [+] MeSH (15 total, 1 Best Bet, 4 Recommended,
2 in the News, 1 Expert, 2 Interest Group, 1 Newsmaker)
            [+] Cardiovascular Diseases
            [+] Cardiac Failure
            [+] Mental Disorders
                                      [+] Dementia
            [+] Immunologic Techniques
                                    [+] Immunologic Assays
```

In one embodiment, in Deep Info, as illustrated in the figure above, the user would often start from a category and then navigate from there. However, this can be problematic because the category’ might not be “understood” (i.e., the category's ontology might not be supported) in other Knowledge Communities in the contextual profile. Semantic wildcards get around this because the interpretation of the context is performed on the fly—the categories are inferred in real-time and not explicitly specified.

In one embodiment, in Deep Info, the seamlessness of the user experience is preserved by supporting intelligent and dynamic navigation. With documents and text (and in some cases, entities), this happens automatically—Dynamic Linking already involves real-time inference and mapping of categories. However, with categories as the source context, things get a bit trickier for the reason described above. To address this, the Information Nervous System supports Intelligent Dynamic Linking. If the source category is not understood (as explicitly specified), the KIS can indicate this in the Deep Info result set. However, the KIS can go a step further: it can then attempt to map the explicit category to semantic wildcards simply by adding the ‘*:’ prefix to the category name (off the category path). It can then rerun the Deep Info query and then return the result set for the new query to the semantic client. The new result set can be tagged as having been dynamically mapped to semantic wildcards. The semantic client can then display a very subtle hint to the user that the Deep Info results were inferred on the fly by the system. Some users might not care, especially if the category name is strong and distinct enough to communicate semantics regardless of the contextual path and the ontology. Some users, however, might care, especially if the explicit source category is unique and distinct from other contexts that might share the same category name.

In one embodiment, Dynamic Deep Info Seeking is a powerful invention that allows the user to seek to Deep Info from any piece of text. First, the user is able to hover over any highlighted text (with semantic highlighting) and then dynamically use the highlighted text as context for Deep Info—the semantic client can detect that the text underneath the cursor is highlighted and then use the text as context. The result can be selected (if not already) and the Deep Info mini-bar invoked with the highlighted text as context (with semantic wildcards added as a prefix—for intelligent processing). This preferably creates a user experience that feels as though the user seeks (without navigating) from a highlighted term to Deep Info on that term.

This feature can also be extended to hovering over any piece of selected text. The user can select the text, hover over it, and then seek to Deep Info using the text as context.

In one embodiment, the integration of Presence in the semantic client has already been described in previous invention submissions. This piece is to add more clarity to Presence in the specific context of Deep Info. In one embodiment, anywhere people are exposed in Deep Info (including in the Deep Info mini-bar), Presence information is integrated as an additional hint. This indicates whether a displayed user is online, offline, busy, etc. The Presence information is integrated using an operating system (or otherwise integrated) API. Verbs are integrated in the Deep Info UI to allow the user to see a displayed user and then open an IM message, send email, or perform some other Presence-related action either directly within the Deep Info UI or via an externally launched Presence-based or IM application.

In one embodiment, the Geography ontology allows semantic regional scoping/searching. This allows queries like Dossier on American Politics from General News. This is simply invoked as Dossier on *:American *:Politics. Other examples are:

1. Dossier on Investments in Asia □ Dossier on *:Asia *:Investments

2. Dossier on Caribbean or African Vacations □ Dossier on *:Vacations AND (*:African OR *:Caribbean)

In one embodiment, we also have an Institutions ontology that would have every company name, school name, etc. This is then added to all General KCs.

In one embodiment, a combination of the following ontologies: General Reference, Products & Services, Geography, and Institutions provide very rich semantic coverage. This is done over time and makes the General KCs more compelling as we upgrade them.

1.) The “Make me an ontology” Red Button, in accordance with an embodiment of the invention

This button allows a Martian who just landed on Earth to create the first pass for an ontology describing previously unknown knowledge domains on Mars. Coming back to Earth, it allows Nervana to generate a new ontology new for domains or sub-domains, perhaps new industries like nanotech, etc.

The professorial part of this involves developing standards and rules by which an ontology can be generated from an existing body of knowledge. The scientific and product development part of this involves creating the Red Button to CONSTANTLY scan through documents on the Web and other sources and generate the ontology based on high-level taxonomic and conceptual inferences that can be made. The generated ontology is a first pass; humans then follow up to refine the ontology.

2.) The “Does this ontology suck?” Red Button, in accordance with an embodiment of the invention

This button can allow a user to quickly determine the quality of an ontology. For all our current ontologies, what is the grade? Which gets an A? And which gets an F? Which ontology is so bad that it shouldn't be used in production, period? And why? What is the basis for determining A, B, C, D, E, or F? What is the scale and how are grades determined? These grades can then be used for our ontology certification and logo program. I also want this to be employed for ontology comparison analysis (A.) are two ontologies semantically similar and if so, how much? B.) is ontology A better than ontology B for knowledge domain K and if so, by how much, and why?). This button should also be tied into a real-time ontology monitor This monitor can constantly track search logs and web logs to determine if an existing ontology is getting stale or is otherwise not representative of the domain of knowledge it should represent. Search lingo changes and the vocabulary around a knowledge domain changes; the real-time ontology monitor makes the “Does this ontology suck?” red button also a “Does this ontology still not suck anymore?” button.

3.) The “Fix this ontology” Red Button, in accordance with an embodiment of the invention

Similar to the “Make me an ontology” red button, this button allows a user to take an existing ontology, integrate it with the real-time ontology monitor, and have recommendations made on how to fix or improve the ontology.

1. In one embodiment, the KIS now understands the following qualifiers:
author: (this restricts the search to the author field)
publisher: (or pub:) this restricts the search to the publisher field
language: (or lang:) this restricts the search to the language field
host: (or site:)—this restricts the search to the host/site from where the item originated
filetype:—this restricts the search to the file extension (e.g., filetype:pdf)
title:—this restricts the search to the title field
body: this restricts the search to the body field
pubdate:—the publication date
pubyear:—the publication year
range:—a number range (format □ range:<start>-<end>).
affiliation:—the affiliation of the author(s) (e.g., Merck, Pfizer, Cetek, University of Washington)

In one embodiment, one can combine these filters at will. The model is also completely extensible—more filters can be added in a backwards compatible way without affecting the system.

e.g., Dossier on Heart Diseases AND lang:eng AND “author :long bh”—find all English publications on Heart Diseases authored by Long BH.

In one embodiment, each qualifier has a corresponding predicate which indicates the basis for the semantic link, linking a document (or other information item) to the concept in question. The table below shows the mapping of the qualifiers to predicates (the actual predicate values are arbitrary but preferably are, and in some cases must be, unique).

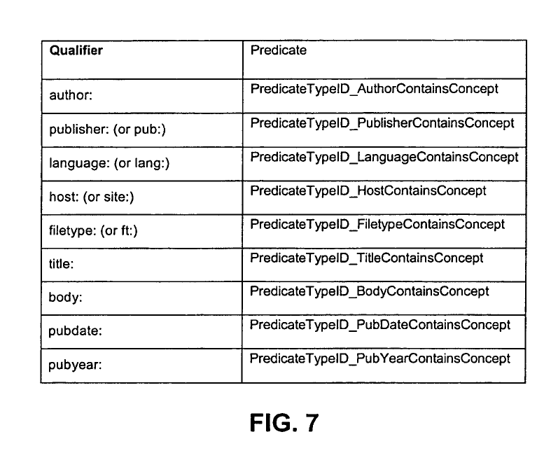

FIG. 7 illustrates a Table Showing Semantic Search Qualifiers and Corresponding Predicates.

In one embodiment, Semantic wildcards (and dynamic linking in general) preferably defer semantic interpretation until run-time (when the query is getting executed). In contrast, a category reference (Uri) has a hard-coded expression for semantic interpretation. Hard-coded category references have the problem of brittleness, especially in the context of ontology versioning. A category path or URI might become invalid if an ontology's hierarchy fundamentally changes. This could become a versioning nightmare. In previous invention submissions, I described how a hard-coded category can be dynamically mapped to get around this problem. With semantic wildcards (or drag and drop), on the other hand, there is no hard-coded path or URI (the wildcards refer to concepts/terms that can be interpreted across ontologies and ontology versions). This is very powerful because it means that an ontology can evolve without breaking existing queries. It is also powerful in that it more seamlessly allows for ontology federation—with different ontologies in a virtual network of Knowledge Communities (KCs)—each wildcard term can be interpreted locally with the results then federated broadly.

In one embodiment, events awareness refers to a feature of the Information Nervous System where the system can understand the semantics of events (end-to-end) and apply special treatment to provide event-oriented scenarios.

1. In one embodiment, first, there are Events Knowledge Communities—for instance, Life Sciences Events. This is similar to Web KC offerings like Life Sciences Market Research and Life Sciences Business Web, Life Sciences Academic Web, and Life Sciences Government Web.

Life Sciences Events allows knowledge-workers semantically keep track of research conferences, marketing conferences, meetings, workshops, seminars, webinars, etc. For instance, imagine questions like: Find me all research conferences on Gastrointestinal Diseases holding in the US or Europe in the next 6 months.

This would be extremely valuable—currently, knowledge workers have no way of semantically and efficiently finding out about conferences in their fields of interest (they often find out about conferences after they might have occurred). NOTE: The query above can involve the Geography ontology (as described above) to allow location-based filters that are semantically interpreted.

This Knowledge Community (KC) can be seeded manually and then filled out with additional business-development (as needed). The seeding would RSS integration (where available) and/or editorial tools (screen-scraping) to generate Event metadata (as RSS) which can then be indexed on a constant basis.

A key idea here involves having a special RSS tag that would indicate to the KIS that an event “expires” at a certain date/time and/or after a certain time-span. When the event “expires” in the KC, the KIS can automatically remove it.

This idea can also be useful with e-Commerce KCs—imagine a semantic index of Sales Events—where a sale might “expire” and become unavailable to users of the index.

2. In one embodiment, the semantic client is “aware” of results that are events and can allow users to add events to their Outlook Calendar (or an equivalent). This can be done via a Verb/Task on a selected “event result.”

3. In one embodiment, the WebUI client can allow users set reminders for events. The WebUI can then email them just before the event occurs (with a configurable window, in a manner partially resembling Outlook). So for example, a user can be able to register for reminders (semantic reminders, if you will) for the sample query I indicated below.

4. In one embodiment, the KIS supports self-aware, expiring events, as described above.

5. In one embodiment, the KIS and the semantic clients also support a new field qualifier, location:, that would allow the user to specify the desired location of an Events semantic search. This can map to a new predicate, PredicateTypeID_LocationContainsConcept. Also, there can be a startdate:, enddate:, and duration: (event duration) qualifiers with corresponding predicates.

Drag and Drop dynamic query generation has been described in the previous invention submission. In one embodiment, this also applies to entities, semantic wildcards, smart copy and paste and other Dynamic Linking invocation models. As noted previously, the query generation rules can result in sequential queries.

When there are multiple SQML filter entries that may require dynamic semantic interpretation and query generation, the resultant query can be very complicated. For performance reasons, the following query reduction/simplification rules are employed, in various embodiments of the invention:

1. If there is only one SQML filter entry, the previously described rules are employed.

2. If there are multiple SQML filter entries and the operator is an OR, the previously described rules are employed. The resultant queries are then concatenated into a master sequential query set. This overall query set is then invoked, with eventual result duplicates elided.

3. If there are multiple SQML filter entries and the operator is an AND, the resultant-query generation rules are a bit more complicated. If there are multiple Best Bet categories generated from the source (the “dragged” object), the categories are added to a resultant list. Else, if there is one Best Bet category, the category is added along with Recommendations categories (if available). Else the Recommendations categories are added to the resultant list (if available). Else, the All Bets categories are added (if available). If there are non-semantic entries (as previously described)—for instance key concepts in the title or body—these are also added to the resultant list. This is repeated for all SQML filter entries. The resultant categories are then added to one master semantic query, which is then invoked with an AND operator.

4. If there are multiple SQML filter entries and the operator is an AND NOT, the rules described for AND (above) are generated and then the resultant query is modified to have an AND NOT operator rather than an AND operator.

As described in the original invention submission, there can be multiple semantic clients that access services exposed by the Information Nervous System. In one embodiment, this is done via an XML Web services interface. There are now two additional semantic clients, in addition to the smart client (the Nervana Librarian): the Nervana WebUI and the Nervana RSS interfaces.

These have several strategic benefits:

1. Low Total Cost of Ownership (no client install)

2. No/minimal training for massive deployments (familiar, Web-based interface)

3. Client flexibility (rich (Librarian) vs. reach (WebUI)); shows programmatic flexibility (system can be programmed/accesses with different clients)

4. Migration path (can start with WebUI; and then migrate to Librarian for power-user scenarios)

The RSS interface is also exposed via HTTP and can be consumed by standard RSS readers. Currently, the RSS interface emits RSS 2.0 data.

The figure below shows an illustration of the WebUI, in accordance with an embodiment of the invention. Notice the command-line interface with semantic wildcards—this provides a lot of the semantic power via a text box. Also, notice the integration of the Dossier Knowledge Requests to provide different contextual views of results.

Any WebUI query can be saved as an RSS query which emits RSS 2.0. This can then be consumed in a standard RSS reader. The RSS interface automatically creates a channel name as follows: Nervana <Knowledge Request> on <Filter>, where <Knowledge Request> is the knowledge request type (Breaking News, Best Bets, etc.), and filter is the search filter.

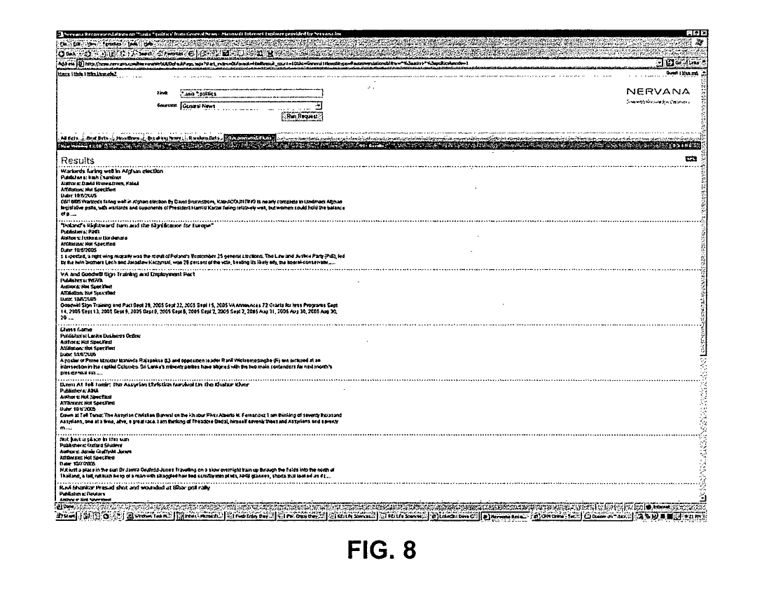

FIG. 8 is an Illustration of a WebUI interface according to an embodiment.

In one embodiment, the Infotype semantic search qualifier is a powerful and special qualifier that is used to specify information types in the Information Nervous System. Information types have previously been described and include types like Presentations, Spreadsheets, Documents, etc. In the previously described Create Request Wizard description, the user could select a Dossier, a Knowledge Request (Best Bets, etc.), an Information request (Presentations, etc.) or a Request Collection. One limitation of this approach is that the user is not able to combine a knowledge type qualifier with an information type qualifier (they are mutually exclusive). However, with the InfoType qualifier, this is now possible. So the user can now, for instance, ask for Breaking News but only those that are Presentations. This can be specified as Breaking News on InfoType:Presentations.

In one embodiment, the KIS adds special info predicates corresponding to each information type. This preferably is a abstraction on top of filetypes—both predicate classes are added to the semantic network. Furthermore, some infotypes yield other infotypes—e.g., a presentation is also a document; in such cases, multiple predicate assignments are issued. Because the infotype predicates are in the semantic network, they can be mixed and matched with other predicate qualifiers, knowledge types, etc. For instance, a user can ask for Best Bets on InfoType:Spreadsheets AND “author:John Smith” (find me best bets that are spreadsheets authored by John Smith).

Here is a sample list of InfoType predicates:
PredicateTypeID_InfoType_Presentation
PredicateTypeID_InfoType_Spreadsheet
PredicateTypeID_InfoType_GeneralDocument
PredicateTypeID_InfoType_Annotation
PredicateTypeID_InfoType_AnnotatedItem
PredicateTypeID_InfoType_Event

In one embodiment, semantic type semantic search qualifiers preferably partially resemble infotype qualifiers except that the qualifier tags themselves indicate the semantic type. This makes it clear to the KIS that only a specific predicate based on entity-detection should be employed. For instance, “person:john smith” indicates to the KIS that only a concept that has been detected to refer to a person should be included in the semantic search. Or place:houston indicates only a place called Houston and not a name called Houston. And so on. This information should be added to the semantic network by the KIS via semantic type predicates. Examples are:
PredicateTypeID_SemanticType_Person
PredicateTypeID_SemanticType_Place
PredicateTypeID_SemanticType_Thing
PredicateTypeID_SemanticType_Event

In one embodiment, time search qualifiers are pre-defined and semantically interpreted qualifiers that refer to absolute or relative time. These don't have to be (nor should they be—in the case of relative times) hard-coded into an ontology—they can be interpreted in real-time by the KIS. The KIS then maps these qualifiers to an absolute time (or time range) IN REAL-TIME (resulting in a live computation of the actual time value) and then uses the resultant value in the semantic query.

Examples, in accordance with various embodiments of the invention:

1. “pubdate:last week”

2. pubdate:today

3. “pubyear:this year”

4. “pubyear:last decade” (is dynamically mapped to a range: query)

5. “startdate:next week” (for events)

6. “duration:two weeks”

Examples of queries that are enabled by time search qualifiers are:

1. Find all events on mathematical models for climate change holding in California next week: All Bets on “*: mathematical models” AND “*:climate change” AND location:California and “startdate:next three months” (Notice that this query also includes the Geography ontology (for the California filter).

2. Find all presentations for request for proposals for communications equipment in the next quarter: All Bets on infotype:presentations AND “*:communications equipment” AND “*:next quarter”

In one embodiment, time ontologies should allow the semantic interpretation and inference of time-related concepts. Examples of time-related concepts are: “twentieth century,” “the nineties,” “summer,” “winter,” “first quarter,” “weekend” (should have terms for Saturday and Sunday), “weekdays” (should have terms for Monday through Friday), etc.

This can allow queries like, in accordance with various embodiments:

1. Find all sales presentations for deals that closed in the third-quarter: All Bets on *:sales AND infotype:presentations AND “*:third quarter”

2. Find research on quantum physics done by Nobel Prize winners in the second half of the twentieth century: Recommendations on “*:quantum physics” AND *:nobel prize” AND “*second half of the twentieth century”.

The triangulation of Time ontologies with Geography ontologies (as described above) can cover the space-time continuum, which is a part of reality.

In one embodiment, a similar model is also applied for numbers—Number Ontologies. This can enable queries with concepts like “six-figures,” “in the millions,” etc. This also is implemented with number search qualifiers.

In one embodiment, historical ontologies preferably partially resemble Time ontologies but rather focus on time in the context of specific historical concepts. Examples:

1. Ancient China (should have concepts that describe all the places and other entities in Ancient China)

2. Pre-colonial Africa

3. Renaissance

In one embodiment, institutional ontologies are extremely powerful and should be (in the preferred embodiment) used as a generic ontologies (like Geography). This has businesses, universities, government institutions, financial institutions, etc. AND their relationships.

Sample queries, in accordance with various embodiments:
Find Breaking News on cancer research but only that done by Big Pharma
Find research on bacteria being done by any company affiliated with Merck (research partners, acquired companies, etc.)
Find Breaking News on job openings in technology companies but only those on the Fortune 500
Find great papers on Gallium Arsenide based semiconductor research but only by accredited European institutions

Find great articles on the possible use of semantics to improve research productivity in Life Sciences but only published by Industry Leaders

In one embodiment, this involves the notion of “institutional people” (thought leaders, executives, influentials, key analysts, etc.), in all humility, which is semantically correlated with an Institutions ontology.

In one embodiment, this ontology is also useful to semantically search for companies and other institutions referred to by acronyms (e.g., GE). Also, this ontology handles common typos. Example: “Bristol-Myers Squibb” (correct spelling) vs. “Bristol Myers-Squibb” (very common typo).

And this ontology also is useful for IP searching, for which the ownership of IP is very useful information.

So a query like: {Find all patents on manufacturing techniques for polymer-based composites owned by DuPont} should bring back patents by DuPont AND companies that have been acquired by DuPont—since DuPont will now own the IP.

In one embodiment, Commentary and Conversations are treated differently in terms of their semantic ranking and filtering algorithms. This is because they are based on publications, annotations, etc. from people in the Knowledge Communities (KCs). The involvement of people is a useful, and in some cases critical axis that determines the basis for relevance. For example, take an email message with the body “Sounds good.” or even something as short as “OK.” In a typical knowledge community using only ontology-based semantic indexing, ranking, and filtering, these messages might be interpreted as being irrelevant or weakly relevant. However, if the author of the email message is the CEO of the company (and the knowledge community corresponds to that company) or if the author is a Nobel Prize Winner, all of a sudden the email message “takes on” a different look or feel. It all of a sudden “feels” relevant, independent of the length of the text or the semantic density of the words in the text.

Another way to think of this is that in knowledge communities, the author or annotator of an information item might contribute more to its “relevance” than the content of the item itself. As such, it can be limiting merely to use ontologies as a source of relevance in this context.

The Dynamic Linking model of the Information Nervous System partially addresses this because the user can navigate using different semantic paths to reach the eventual item—the paths then become a legitimate basis for relevance, in addition to—or regardless of—the semantic contents of the item itself.

However, preferably several changes are made to the KIS indexing algorithms when indexing commentary or conversations:

1. The semantic threshold is set to zero—all items should be indexed

2. The ranking should be biased in favor of time and not semantic relevance

(preferably in a manner partially resembling email)

3. An alternative to a formal Commentary context template (knowledge request) can be to have All Bets ranked by time and not semantic relevance—only for a specially defined and configured “Discussions” knowledge community (that is treated differently)

In one embodiment, a model for ontology mapping was described in a previous invention submission. It is useful to have a model for comparing and mapping ontologies. The model described here can generate a map that shows how several (2 or more) ontologies are similar (or not). Given N ontologies O1 through ON, semantically index (using the Information Nervous System) a large number of documents using all ontologies. For every category in each ontology and for each document in the corpus, generate a table that with columns for Best Bets and Recommendations. These columns can indicate the semantic strength of the category in the given document.

Once these tables are generated, a separate set of steps are invoked to map categories across the ontologies, in accordance with various embodiments:

1. For every category that is a Best Bet, find every category in every other ontology that is a Best Bet. Assign a high score (e.g., 10) for this mapping. For parents of the latter categories, assign a high but lesser score (e.g., 8). An additional scalar factor (weakening the score) can be applied for broader categories (moving up the hierarchy chain).

2. For every category that is a Recommendation, find every category in every other ontology that is a Recommendation. Assign a median score (e.g., 6) for this mapping. For parents of the latter categories, assign a high but lesser score (e.g., 4). An additional scalar factor (weakening the score) can be applied for broader categories (moving up the hierarchy chain).

3. Categories that don't qualify based on the above rules should be assigned a score of 0.

4. In one embodiment, All Bets are not analyzed.

In one embodiment, at the end of this process, all the scores are tallied. For every category, a ranked list of every category in every other ontology is generated (from highest to lowest scores, greater than 0). This can then represent the ontology assignment/comparison map. The larger and more relevant the corpus to the entire ontology set, the better. This map can then be used to map categories across ontology boundaries—during indexing. This is also very powerful.

In one embodiment, Federated and merged semantic notifications refers to a feature of the Information Nervous System that allows users to have rich semantic notifications from a federation of knowledge communities, organized by profile, and across a distributed set of servers.

In one embodiment, Every KIS is configured with a master notification server that it then communicates notifications too (based on a polling frequency and on registered user semantic-requests). Federated identity and authentication can be used to integrate user identities. The master notification servers then merge all the notification results, elide duplicates, and then notify the registered user.

Alternatively, the user can register for notifications from specific KISes (and KCs) which can then notify the users (via email, SMS, etc.).

Alternatively yet, these notifications can be sent to a Notification Merge Agent which lives centrally on a special KIS. This merge agent can then mark all the source profiles (by GUID), merge and organize the notification results by profile, and then forward the merged and organized results to the registered user.

In one embodiment, this refers to a feature to allow the user to get semantic wildcard equivalents from the semantic client categories dialog. The categories dialog have a “Copy to Clipboard” button—enabled only when there are selected categories, in an embodiment. When this button is clicked, the selected categories can be copied to the clipboard as text.

### EXAMPLE

If “Heart Diseases” and “Muscular Diseases” are selected as categories, the following can be copied to the clipboard as text:

‘*:Heart Diseases” OR “*:Muscular Diseases”

The user can then go back to the edit control in the standard request or the command line on the Home Page and click Paste. The user can then change the text to AND, add parentheses, change the wildcard to a specific ontology alias qualifier (e.g., Cancer or MeSH), etc.

In one embodiment, this is the semantic client namespace item serialization model and file formats—for Request, Results, and Profiles (and other non-container namespace items) Saving and Sharing (e.g., email):

A request is saved (or emailed) as a Zipped folder (read: an easily sharable file).

In one embodiment, the Zipped folder can contain the following files and folders:

Results (this folder can contain the results as they were when they were saved):

[Request Name].XML (the results as RSS)
If the request is a Dossier, there can be one XML file for each request type

[Request Name].HTM (the results saved as an HTML file)

If the request is a Dossier, there can be one HTML file for each request type

The HTML file can be a report generated from the results XML. It can have lists and/or a table showing each result and it metadata. Also helpfully (from a usability standpoint), it can have hyperlinks to the result pages, which a TXT file would not have.

Request (Original Profile) (this folder can contain the XML (SQML) that represents the semantic query/request AS IT WAS WHEN IT WAS SAVED)
[Request Name].XML

The request XML can contain all the state in the original request, including the KCs for the request profile. This allows other users to view the identical request, since their profile information might be different.

Request Info.HTM (this file can describe the request, its filters and the original profile, including the names of its KCs and category folders)

This file can also contain the metadata for the request—e.g., the creation date/time, the last modified date/time, the request type, the profile name, etc.

Request (Any Profile) (this folder can contain the XML (SQML) that represents the semantic query/request WITHOUT ANY PROFILE INFORMATION)

[The request XML can contain all the state in the original request, but only with the request filters, excluding the KCs for the request profile. This allows other users to view the request in their own profiles, if the filters are what they find interesting]
Request Info.HTM (this file can describe the request and its filters)

This file can also contain the metadata for the request—e.g., the creation date/time, the last modified date/time, the request type, etc.

Readme.HTM
This file can describe the contents of the folder

This file can also contain the metadata for the request—e.g., the creation date/time, the last modified date/time, the request type, etc.

NOTE: In one embodiment, the Zipped folder name can prefixed with “Nervana.”

Example: Nervana Dossier on Cell Cycle AND Protein Folding.ZIP

A similar model is employed for serializing profiles—profiles can contain folders with each request, in addition to the profile settings.

Why is the ZIP Format preferred in some embodiments?

1. Allows seamless pass through thorough most email systems that screen out unknown or suspicious file types (this precludes us from having a custom file type until post critical mass)

2. One file makes for ease of sharing, saving, and management

3. Internal folder structure allows for rich metadata display with multiple views of the request state (in files and sub-folders)

4. Zip is an open format with broad industry support. Zip management is now built into Windows XP allowing for easy management of the saved request and results. Furthermore, there are many third-party Zip SDKs for customers that might want to generate reports from saves Nervana requests/results. For example, a customer might want to write an application that scans through file or Web folders containing saved Nervana requests/results, extracts the contents from the Zip folders, and then manipulates, analyzes, aggregates, or otherwise manages the saved RSS results within each zipped folder. So a customer (say, Zymogenetics) can have an application that monitors a shared folder, opens the zipped Nervana folders, and then aggregates the RSS results (from different requests) to, say, database tables or spreadsheets for analysis.

5. Compression: Because many of the elements in the saves folder can be in the XML format, Zip can result in a very high (and significant) compression ratio (up to 10:1 from published studies/reports and also from my experience).

6. Malleability and Extensibility: Zip can provide backward and forward compatibility for the “format.” Old versions of the Librarian can be able to “open” requests from future versions and vice-versa. Zip would also allow us (in large measure) to add and/or remove components from the “format” without affecting the core of the “format.”

In one embodiment, Newsmakers refers to authors of inferred news (within one or more agencies or knowledge communities) in a given context. Newsmakers are “known” (provable identities) within a user's knowledge communities. Furthermore, Newsmakers are members of agencies (knowledge communities) so a user can continue to navigate with a newsmaker as the virtual pivot object—a user can find a Newsmaker, navigate to Headlines by that Newsmaker, drag and drop one of those Headlines to find semantically relevant Best Bets, navigate to the Interest Group for one of those Best Bets, etc.

In an alternative embodiment, Newsmakers can also be people featured in the news—the system maps extracted concepts, perform entity detection to detect names, and attempts to authenticate those names against names in the agency. The system can then assign a similar Newsmaker predicate that indicates that the semantic link has uncertainty (e.g., PREDICATETYPEID_MIGHTBENEWSMAKERON). The “Newsmaker” context template query can then include this predicate as part of the Newsmaker query—but in some cases, the predicate can also be excluded (this model preserves flexibility). The risk with this is that names like “John Smith” might have thousands of potential candidates—as such the system might not be able to disambiguate the different candidates. In one embodiment, the authors should be authenticated by their email address so this problem wouldn't occur.

In closing, in one embodiment, Newsmakers are authenticated authors only (and members of the agency (knowledge community)). A separate “In the News” query is generated for entities (including unauthenticated people) that are featured in the news. But there are no authenticated Newsmakers because they would lead to a wrong chain of semantic inference.

In one embodiment, RSS Commands/Verbs are special signals embedded in RSS that direct the KIS to take actions on specific information items. These are specified with namespace-qualified elements that correspond to specific verbs that the KIS invokes. Examples:

1. meta:insert or meta:add (instructs the KIS to index the RSS item)

2. meta:delete or meta:remove (instructs the KIS to delete the RSS item)

3. meta:update (instructs the KIS to update the RSS item)

In one embodiment, Let n be the total number of keywords that are semantically relevant to all the filters in the query. And let k be the number of semantic or keyword filters in the query.

In the general case, the order of magnitude of total number of combinations is by which the n items can be arranged in sets of k is represented by the formula:

$${}_{ }^{n}{C}{}_{k}^{ } = \frac{{}_{ }^{n}{P}{}_{k}^{ }}{k !}$$

where:

$${}_{ }^{n}{P}{}_{k}^{} = \frac{k !}{( n - k ) !}$$

Also, note that in this case, we use combinations and not permutations because the order of selection for semantic queries does not matter (A AND B=B AND A).

For union (OR) queries, this count is accurate. For intersection (AND) queries, and if there are multiple filters, the exact count is less than this (although of the same order of magnitude) because exclusions generally must be made for the keyword combinations within the same category filter.

Example:

Take the semantic query: Find all chemical leads on bone diseases which are available for licensing.

This can be expressed in Nervana as: All Bets on Bone Diseases (MeSH) AND Chemical (CRISP)

In the text-box interface, this can also be expressed as a search for “MeSH:Bone Diseases” AND CRISP:Chemical. Alternatively, this can be expressed as a cross-ontology

Search for “*:Bone Diseases” AND *:Chemical but we can focus on the ontology-specific searches here in order to simplify the analysis.

Bone Diseases (MeSH) currently has a total of 308 keywords representing the many types of bone diseases and their synonyms and word variants. Chemical (CRISP) has a total of 5740 keywords representing the very many number of chemical compounds and their synonyms and word variants.

Adding the keyword ‘licensing,’ this amounts to a total of 6049 keywords.

Assuming 2 keywords per search, and plugging this into the equation above, this can result in the following:

$${}_{ }^{n}{P}{}_{k}^{ } = \frac{6049 !}{( 6049 - 2 ) !} = 6049 * 6048 = 36584352$$

$$Therefore , {}_{ }^{n}{C}{}_{k =}^{ } 36584352 / 2 != 18292176$$

In other words, it can take approximately 18.3 million 2-keyword searches to approximate the semantic query represented above (even discounting semantic ranking, filtering, and merging). And because these are 2-keyword queries, the quality of the search results (even in the non-semantic domain) can suffer greatly.

Assuming 3 keywords per search, and plugging this into the equation above, this can result in the following:

$$\begin{matrix}{}_{ }^{n}{P}{}_{k}^{ } = \frac{6049 !}{( 6049 - 3 ) !} \\ = 6049 * 6048 * 6047 \\ = 221225576544\end{matrix}$$

$$Therefore , {}_{ }^{n}{C}{}_{k =}^{ } 221225576544 / 3 \text{!} = 36870929424$$

In other words, it can take approximately 36.9 billion 3-keyword searches to approximate the semantic query represented above (even discounting semantic ranking, filtering, and merging). Adding a third keyword would likely improve the quality of the search results (even in the non-semantic domain). But this results in an even more exponential explosion in the number of keyword searches that may be necessary to fully exhaust all the possibilities encapsulated in the semantic query.

4-keyword searches can result in an astronomical number of searches.

And so on.

Additional Combinatorial Explosions

And then multiply this by the different kinds of queries (like Breaking News, etc.). So if the researcher wants the results grouped in, say 6 contexts, the total can be 6 times the number of keyword queries shown above. And then multiply this by the different silos of knowledge over which the researcher must repetitively search. This represents the total astronomical number of searches that may be required to approximate a federated Nervana Dossier.

Matters are made worse yet as the queries get more complex. For instance, if the query was: Find all chemical leads applicable to both Bone and Heart Diseases and which are available for licensing, this would correspond to a Dossier on Bone Diseases (MeSH) AND Heart Diseases (MeSH) AND Chemical (CRISP) and ‘licensing’. The combinations can explode to an even more astronomical number because the value n above would be much higher due to the number of keywords that represent all the types of Heart Diseases.

In one embodiment, to efficiently index real-time newsfeeds, some smarts have been added to the KIS and the indexing pipeline. First, a staging server hosts a daemon which downloads news items and then indexes them in an intermediate staging index. This index is then divided up into multiple channels—allowing for indexing scale-out (with each KIS indexing one channel). More channels can then be added to provide more parallelism and less simultaneous read-write (while indexing)—in order to improve both query and indexing performance.

Examples of channels are: LifeSciences, GeneralReference, and InformationTechnology.

Examples of corresponding URLs are:

```
            Life Sciences: http://Caviar/NDC_SQL/DefaultPage.aspx?-
            channel=lifesciences
            General Reference:
http://Caviar/NDC_SQL/DefaultPage.aspx?channel=generalreference
            Information Technology:
http://Caviar/NDC_SQL/DefaultPage.aspx?channel=
informationtechnology
```

In one embodiment, the connector's ASP.NET page takes an additional parameter Since, also case-insensitive. The format of time should be yyyy-mm-ddTHH:mm:ss. For example: 2005-06-29T16:35:43. This can be easily obtained in C# by calling date.ToString(“s”), where date is an instance of System.DateTime structure. The paging parameters are as earlier: Start and PageSize.

In one embodiment, the connector emits RSS 2.0 data which is mapped from the staging index (with the news items). The RSS 2.0 data indicates that the data is from a Nervana Data Connector. There is also a paramsSupported field which indicates to the KIS which parameters the connector supports. Once the KIS downloads the RSS, it parses it. It then checks to see if the RSS is from a Nervana Data Connector. If it is, it then checks the paramsSupported field. If this is populated, it then checks if the “since” parameter is one of the comma-delimited items in the field. If the “since” parameter is found, the KIS then makes note of the current time. It continues to index the RSS and page through until it reaches the end of the RSS stream. At that time, and when the KIS starts re-indexing (the next time), it adds the since parameter to the connector URL query string with the time indicated above (the time since when the “last” indexing round began). This preferably is akin to the KIS asking the connector for only those data items that it (the staging index) has added “since” the last indexing round. This is a very efficient way to incrementally index news in real-time—it ensures that new items are indexed without the I/O overhead of a full incremental index.

Here is a snippet from an RSS 2.0 item generated from a News connector:

```
          <?xml version=“1.0” encoding=“utf-8” ?>
      − <rss version=“2.0” xmlns:dc=“http://purl.org/dc/elements/1.1/”
xmlns:meta=“http://schemas.nervana.com/xmlns/rss_2_0_meta.html”>
      − <channel>
          <title>GeneralReference2</title>
          <category>Nervana Data Connectors</category>
          <generator>Nervana Data Connector for SQL</generator>
          <meta:paramsSupported>Channel,Start,PageSize,Since,FilterNDays,
Order</meta:paramsSupported>
          <meta:startIndex>0</meta:startIndex>
          <meta:endIndex>999</meta:endIndex>
          <language>en-us</language>
      − <item>
<meta:robots>nofollow</meta:robots>
<dc:language>English</dc:language>
<title>Oxford student murdered in ‘honour killing’</title>
<pubDate>10/6/2005 11:43:00 PM</pubDate>
<author />
<dc:publisher>The Tribune</dc:publisher>
<description />
<link>http://c.moreover.com/click/here.pl?z402461455&z=700238245</link>
<guid isPermaLink=“false”>402461455</guid>
</item>
```

The nofollow meta tag is added accordingly, based on whether the link is accessible or not.

In one embodiment, the Nervana Knowledge Center comprises a Federated universe of Nervana-powered content, providing the transformation of Information to Knowledge. The Knowledge Center can have semantically indexed content, People, and annotations.

1. Smart News (General News and Domain-Specific News)

2. Smart Patents (General Patents and Domain-Specific Patents)

3. Smart Blogs (merely a semantic index of blogs).

4. Smart Marketplace: This is the e-commerce scenario and includes sponsored listings that are semantically indexed. The KCs therein can be first-class KCs (with people, annotations, etc.). I contend that if there is enough value in the content and the medium, people can independently subscribe (the one person's ad is another person's content scenario I described recently). Examples include:
Products
Jobs (postings and resumes)

5. Nervana-Run Research KCs (e.g., Semantic/Smart Medline).

6. Nervana-Run Domain and Scenario-Specific KCs: Examples include Compliance, Sarbanes-Oxley, etc.

7. Smart Web (domain-specific):
Business Web
Academic Web
Government Web

8. Smart Libraries: This is where we can preferably partner with content providers like Science Direct, Elsevier, etc. who have been looking for premium revenue channels for many years. There are two possible models here. In one model, they can provide abstracts and maybe full-text to us since we can be driving revenue to them via smarter discovery. We can host the KCs and own/manage the initial consumer relationship. In another model, they can host KCs themselves and pay us licensing fees for our technology.

NOTE: Smart Libraries can have ALL the tools in the toolbox. They can be first-class Knowledge Communities, they can have people, they can have annotations, etc. See more below.

9. Smart Groups: Smart Groups are like a semantic (knowledge-oriented) equivalent of blogs. The scenarios here are numerous. There are many thousands of knowledge communities around the world—on everything from gene research to fly-fishing. Users can first sign up (maybe for $5 a month) as members of the Nervana Network. As a member, you are then able to create and/or moderate Smart Groups. Smart Groups are different from regular groups (like Yahoo Groups) or blogs in that:
They are semantically and context-aware. Knowledge types like Interest Group, Experts, Newsmakers, Conversations, Annotations, Annotated Items, can provide semantic access to community publications and annotations.
Semantic threads (a beautiful invention which is in one of our more recent patent applications) a Conversations become first-class semantic objects that can be returned, ranked, and navigated.
The Knowledge Toolbox: All the tools in our toolbox a Breaking News, Live Mode, Deep Info, etc. can be applied to Smart Groups. These tools do not apply to regular (information) groups on the Web.
Semantic navigation (Deep Info): Emphasis is due here. Smart Groups can be semantically navigated via Deep Info. The semantic paths are at the knowledge level.
Dynamic Linking: Users can be able to navigate from their desktop to Smart Groups, to say, Newsmakers within those Groups, to the annotations by those Newsmakers, and then to relevant knowledge IN DIFFERENT KNOWLEDGE COMMUNITIES—all at the speed of thought.
Awareness: Live Mode and the Watch List can be extended to display Newsmakers. Newsmakers can be actionable—so a user can see Newsmakers and immediately start to navigate/explore.
Federation: Client and server-side

Examples of Smart Groups: Research communities, virtual communities across companies (including partners, suppliers, etc.), classes in schools (e.g. working on specific projects), informal communities of interest around specific area, etc. Imagine a group of researchers that are able to annotate results from Nervana Semantic Medline (after a Drag and Drop) in their own Smart Groups, and create semantic threads based on results from Medline, and then annotate Smart News results around those semantic threads.

10. Smart Books: in partnership with a large aggregator like Barnes & Noble. Imagine being able to subscribe to a Nervana Smart Books KC and semantically find books with semantic wildcards and the like. Now imagine being able to dynamically link that to Smart Groups within (Smart Books a moderated by Nervana) OR your own Smart Groups (moderated by you or a friend/colleague).

11. Smart Images: in partnership with a large aggregator like Getty or Corbis. Imagine being able to semantically find professional or amateur photographs by dragging and dropping a picture from your desktop (more on this later). And then creating semantic threads around the pictures you find—with other hobbyists that like photography as much as you do (in your Pictures-based Smart Groups). The provider can be responsible for providing rich annotations to the books.

12. Smart Media (Music and Video): in partnership with large music and video (including live broadcast) aggregators. The key value proposition here is that reviews become semantic and context-aware. Communities of interest can be formed around music genres, movies, etc. This needs to be more tightly moderated because it is more consumer-oriented. ALL the tools in the toolbox can preferably apply.

In one embodiment, Live mode has been described in previous applications. It is preferably a Watch List of one and is aimed at providing awareness-oriented presentation for a specific request (including special requests and Dossiers) or request collection. It allows users to track timely results in the context of a request or request collection.

In one embodiment, The Presenter periodically issues queries to the KISes in the contextual profile for a request in Live Mode. A request can be in normal mode or live mode. The Presenter also sorts the results based on timeliness and provides additional functionality for handling News Dossiers (previously described) and for guarding against KC starvation in the case of federated profiles.

The Presenter can have a configurable refresh rate and other awareness parameters. On the UI side, the skin polls the Presenter for results. The Presenter polls the KISes and then places the results in a priority queue (as previously mentioned). The skin then picks up the results and shows special UI to indicate recently added results, freshness spikes, an erosion of freshness (fade), etc.

The Presenter guards against KC starvation in federated profiles by making sure results from a high-traffic KC don't completely drown out results from lower-traffic KCs. The Presenter employs a round-robin algorithm to ensure this.

The Live Mode skin can choose to display the metadata for the results in its own fashion. In addition, the skin can creatively display UI to indicate the relative freshness and “need for attention.” Attributes that can be modeled in the UI are:

1. Activity: This indicates the rate of change of results.

2. Freshness: This indicates how old an individual result is. The skin can show UI for new results differently from old results (e.g., in brighter colors, bigger fonts, etc.)

3. Spike Alert: A Spike Alert is generated/fired when a new result is the first fresh result over a given period of time. The Presenter can set a timer; if the timer expires with no results then a flag can be set. The very next “fresh” result would trigger a Spike Alert in the UI. The arrival of a new result resets the timer. The Spike Alert is designed to draw the user's attention to a given result. The methods of drawing attention may include a small sound, a pop up alert window, a color change, or a movement of page elements.

While a preferred embodiment of the invention has been illustrated and described, as noted above, many changes can be made without departing from the spirit and scope of the invention. Instead, the invention should be determined entirely by reference to the claims that follow.

The embodiments of the invention in which an exclusive property or privilege is claimed are defined as follows:

1. A system, comprising:
a semantically integrated knowledge retrieval, management, delivery and presentation system.
